(19) United States
(12) Patent Application Publication
(10) Pub. No.: US 2006/0225531 A1
(43) Pub. Date: Oct. 12, 2006

(54) Clamp for a composite steering interface for a bicycle

(75) Inventor: Christopher P. D'Aluisio, Watsonville, CA (US)

Correspondence Address: MICHAEL BEST & FRIEDRICH, LLP, 100 E WISCONSIN AVENUE, MILWAUKEE, WI, 53202, US

(73) Assignee: Specialized Bicycle Components, Inc., Morgan Hill, CA (US)

(21) Appl. No.: 11/084,351

(22) Filed: Mar. 18, 2005

(51) Int. Cl. B62K 21/12

(52) U.S. Cl. 74/551.1

(57) ABSTRACT

A stem for a bicycle. The stem including a clamp portion that defines a fork-receiving aperture having a size and a first flange that is integrally-formed as part of the clamp portion and extends from the clamp portion. A second flange is integrally-formed as part of the clamp portion and extends from the clamp portion. The second flange is spaced apart from the first flange and a first clamp interface member is in contact with the first flange. A second clamp interface member is in contact with the second flange such that movement of one of the first clamp interface member and the second clamp interface member toward the other of the first clamp interface member and the second clamp interface member reduces the size of the fork-receiving aperture.

### BACKGROUND

The present invention relates to a steering interface for a bicycle. More particularly, the invention relates to a clamp for a composite bicycle steering interface that attaches the steering interface to a front fork.

Bicycles generally include a steering interface that allows a rider to steer the bicycle. The steering interface generally includes a handlebar that provides a convenient place for a rider to place his or her hands during a ride and a stem that connects the handlebar to the remainder of the bicycle.

Many different shapes of handlebars are available. The rider typically decides on the shape of the handlebar based on the type of riding in which the rider engages, on rider preferences, and/or on the fit for the rider's hand. For example, mountain biking may require a different shaped handlebar when compared to touring or road racing.

In most bicycles, the front fork of the bicycle is rotatable to turn the front wheel. The stem attaches to the front fork at one end and supports the handlebars at the opposite end. Thus, it is important that the stem be firmly attached to the front fork. In most designs, the stem positions the handlebars away from the steering axis of the front fork.

### SUMMARY

The present invention provides a clamp for a bicycle steering interface. The steering interface preferably includes a handlebar and a stem that can be integrally formed as a single component from a composite material. The stem includes a clamp portion that defines a fork-receiving aperture. Flanges extend from the clamp portion and are positioned on either side of a split. Clamp hardware members are positioned adjacent each of the flanges and are movable toward one another to reduce the size of the fork-receiving aperture to clamp the stem to the front fork. In preferred constructions, the clamp hardware members each include one through bore and one threaded bore. The clamp hardware members are similar to one another such that a single common component can be used as either hardware member. A fastener passes through the first hardware member and both flanges before threadably engaging the second hardware member. A second fastener passes through the second hardware member and both flanges before it threadably engages the first hardware member. The surface of each hardware member closely matches the surface of the flanges such that as the fasteners are tightened, the clamping force is spread by the hardware members across the area of the flanges.

### BRIEF DESCRIPTION OF THE DRAWINGS

FIG. 1 is a side view of a bicycle including a steering interface embodying the present invention;

FIG. 2 is a perspective view of the steering interface of FIG. 1 including a stem and a handlebar;

FIG. 3 is an enlarged perspective view of the stem and handlebar of FIG. 2;

FIG. 4 is a partial section view of the stem taken along line 4-4 of FIG. 3;

FIG. 5 is section view of the stem taken along line 5-5 of FIG. 3;

FIG. 6 is a perspective view of a mold suited for use in manufacturing the steering assembly of FIG. 1;

FIG. 7 is an exploded perspective view illustrating an alternative assembly method;

FIG. 8 is an exploded perspective view illustrating another alternative assembly method;

FIG. 9 is an exploded view of the clamp portion of the steering interface of FIG. 1;

FIG. 10 is a perspective view of a clamp hardware member; and

FIG. 11 is a section view of the clamp portion taken along line 11-11 of FIG. 9.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

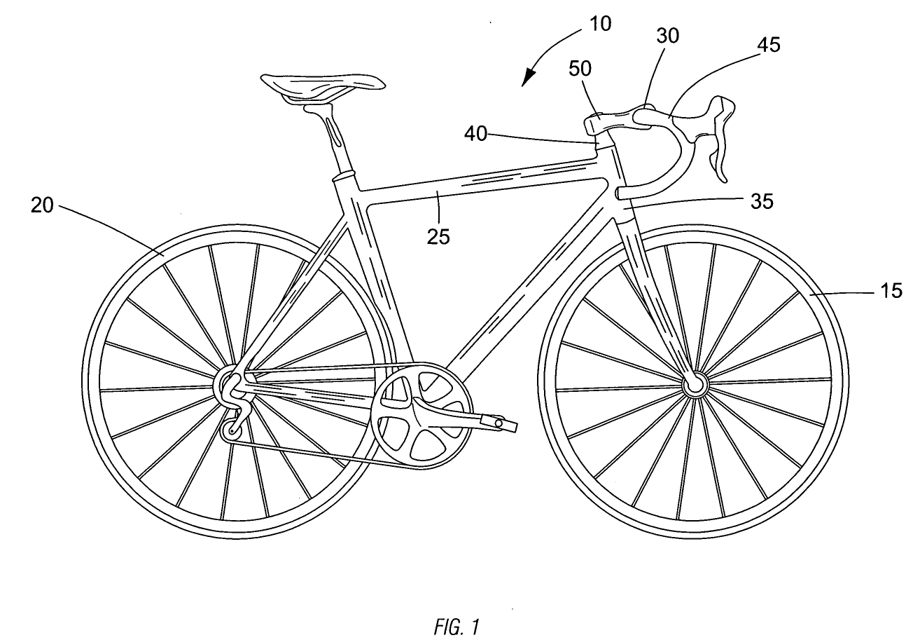

FIG. 1 illustrates a bicycle 10 that includes a front wheel 15, a rear wheel 20, a frame 25, and a steering assembly 30. The frame 25 includes a head tube 35 that engages and supports a steerer tube 40 for pivotal movement about a steering axis. Generally, the steerer tube 40 extends through and above the head tube 35 to provide an attachment point for the steering assembly 30. The steerer tube 40 is generally part of the front fork which supports the front wheel 15 of the bicycle 10 such that movement of the steering assembly 30 produces a corresponding movement of the front wheel 15.

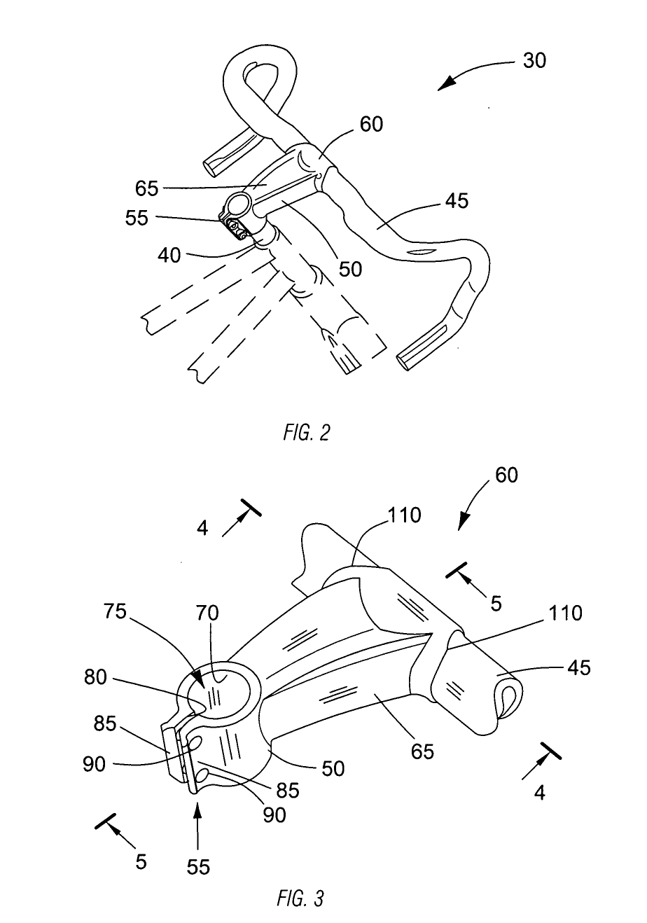

Turning to FIG. 2, the steering assembly 30 is illustrated attached to the top of the front fork, or the steerer tube 40. The steering assembly 30 includes a handlebar 45 and a stem 50. While the illustrated handlebar 45 is a drop bar, one of ordinary skill in the art will realize that virtually any bar style could be employed with the present invention. In addition, while an integrated handlebar 45 and stem 50 assembly is illustrated herein, the present invention can be used with many other arrangements including stems 50 that are not integrated with handlebars 45.

The stem 50 is preferably formed from a composite material such as a carbon/epoxy composite. Of course other materials (e.g., plastics, fiberglass composite, Kevlar composite, or other composites, and the like) could also be employed to form the stem 50. The stem 50 includes a steerer clamp end 55, a handlebar-engaging end 60, and a wall portion 65. The steerer clamp end 55, better illustrated in FIG. 3, includes a substantially cylindrical surface 70 that defines a front fork-receiving opening 75. The cylindrical surface 70 includes a split 80 that extends the length of the cylindrical surface 70 and allows the fork-receiving opening 75 to expand and contract slightly. The steerer clamp end 55 also includes two flanges 85 disposed along either side of the split 80. The flanges 85 extend outward from the cylindrical surface 70 such that they are substantially parallel to one another and extend substantially the full the length of the split 80.

Apertures 90 extend through each flange 85 and align with one another. The apertures 90 provide a space for receiving fasteners that can be employed to reduce the size of the fork-receiving opening 75 such that the cylindrical surface 70 clamps the steerer tube 40. In the illustrated construction, two apertures 90 extend through each flange 85. However, as one of ordinary skill in the art will realize, a single aperture 90, or three or more apertures 90 and a corresponding number of fasteners could be employed if desired.

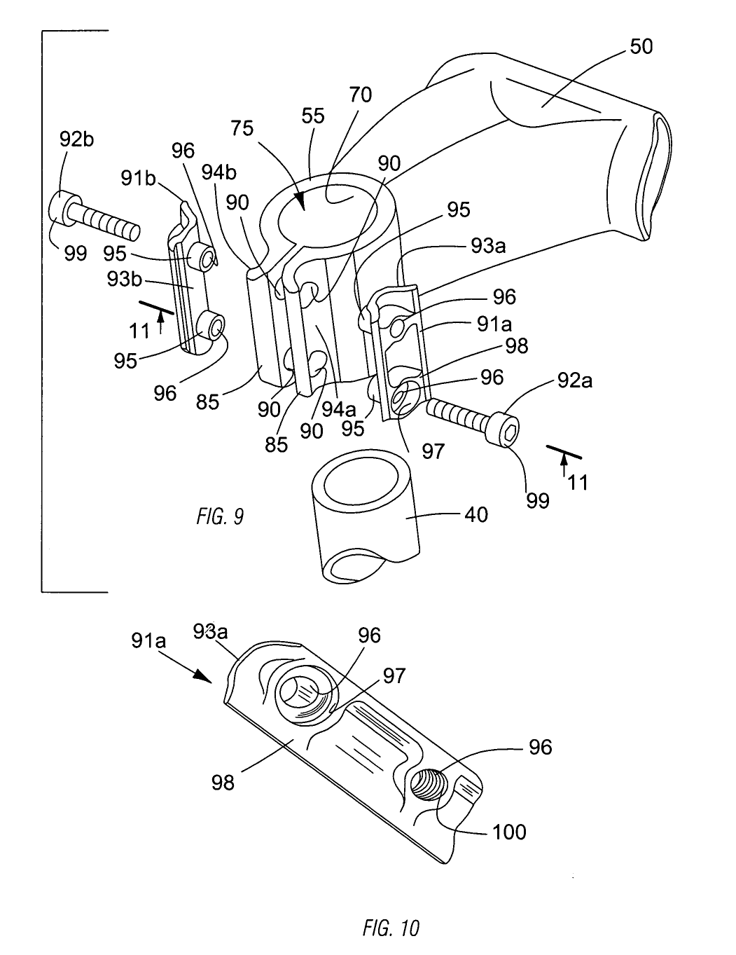

FIG. 9 illustrates one construction of the steerer clamp end 55 that employs two clamp interface members in the form of clamp hardware members 91a, 91b and two fasteners 92a, 92b to tighten the steerer clamp end 55 and fixedly attach the stem 50 and the steering assembly 30 to the steerer tube 40. In a preferred construction, the clamp hardware members 91a, 91b are manufactured from a metallic material such as steel or aluminum, with other materials (e.g., other metals, ceramics, plastics, composites, and the like) also being suitable for use. Each clamp hardware member 91a, 91b includes a mating surface 93a, 93b that is contoured to closely match an exposed surface 94a, 94b of the flanges 85. Thus, when the clamp hardware members 91a, 91b are positioned adjacent the flanges 85, there is significant surface contact between the mating surfaces 93a, 93b and the exposed surfaces 94a, 94b. FIG. 11 illustrates the level of surface contact between the mating surfaces 93a, 93b and the exposed surfaces 94a, 94b. As illustrated, each exposed surface 94a, 94b includes a hook portion 200, a central portion 205, and a contoured portion 210. Each mating surface 93a, 93b includes a hook portion 215 that closely receives the hook portion 205, a central portion 220 that closely receives the central portion 205 and a contoured portion 225 that closely receives the the contoured portion 210. The close fit allows the hardware members 91a, 91b to evenly distribute the stress that results from tightening the clamp.

Each clamp hardware member 91a, 91b also includes two cylindrical bosses 95 that are sized to fit within the apertures 90 that extend through the flanges 85. Both of the cylindrical bosses 95 include through bores 96 that allow for the passage or receipt of one of the fasteners 92a, 92b.

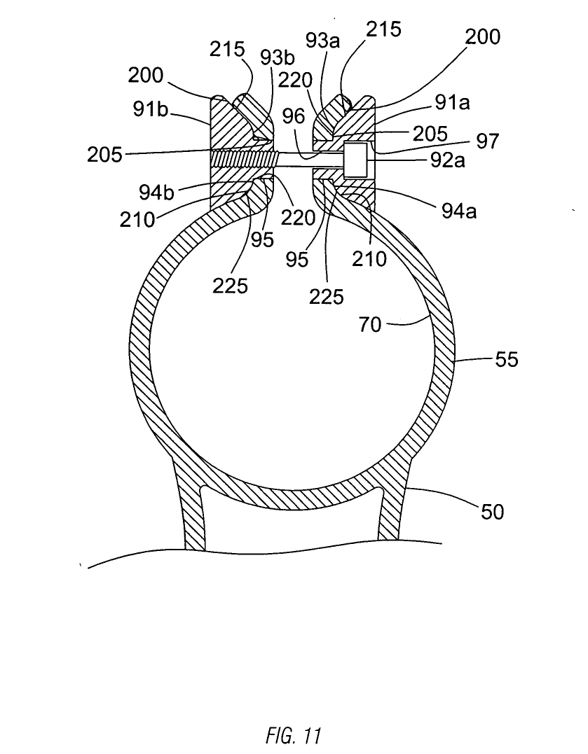

As illustrated in FIG. 10, each clamp hardware member 91a, 91b includes a counterbore 97 centered on one of the through bores 96 that extends from a surface 98 opposite the mating surface 93a, 93b toward the mating surface 93a, 93b. The counterbore 97 is sized to receive a head 99 of the fastener 92a, 92b when the clamp hardware member 91a, 91b is positioned adjacent the steerer clamp end 55 and the fasteners 92a, 92b are tightened. The through bore 96 opposite the counterbore 97 of each hardware member 91a, 91b includes threads 100 that match the threads of the fasteners 92a, 92b.

Returning to FIG. 9, the steerer clamp end 55 is assembled by first positioning one of the hardware members 91a, 91b adjacent the exposed surface 94a, 94b of each flange 85. Two identical hardware members 91a, 91b can be used, with one of the hardware members 91b being inverted relative to the other hardware member 91a. The first fastener 92a passes through the through bore 96 of the first hardware member 91a, through the apertures 90 in the flanges 85, and engages the threads 100 of the opposite hardware member 91b. The second fastener 92b passes through the through bore 96 in the second hardware member 91b, through the apertures 90 in the flanges 85, and engages the threads 100 of the through bore 96 of the first hardware member 91a. As the fasteners 92a, 92b are tightened, the clamping force generated is spread across the entire flange 85 by the hardware members 91a, 91b. In addition, the use of a single through bore 96 with clearance and a single through bore 96 with threads 100 in each hardware member 91a, 91b allows for the use of a single common part on both of the flanges 85, without the use of additional hardware such as nuts or washers. Of course, other constructions provide two through bores in each hardware member 91a, 91b and use nuts to engage the fasteners 92a, 92b.

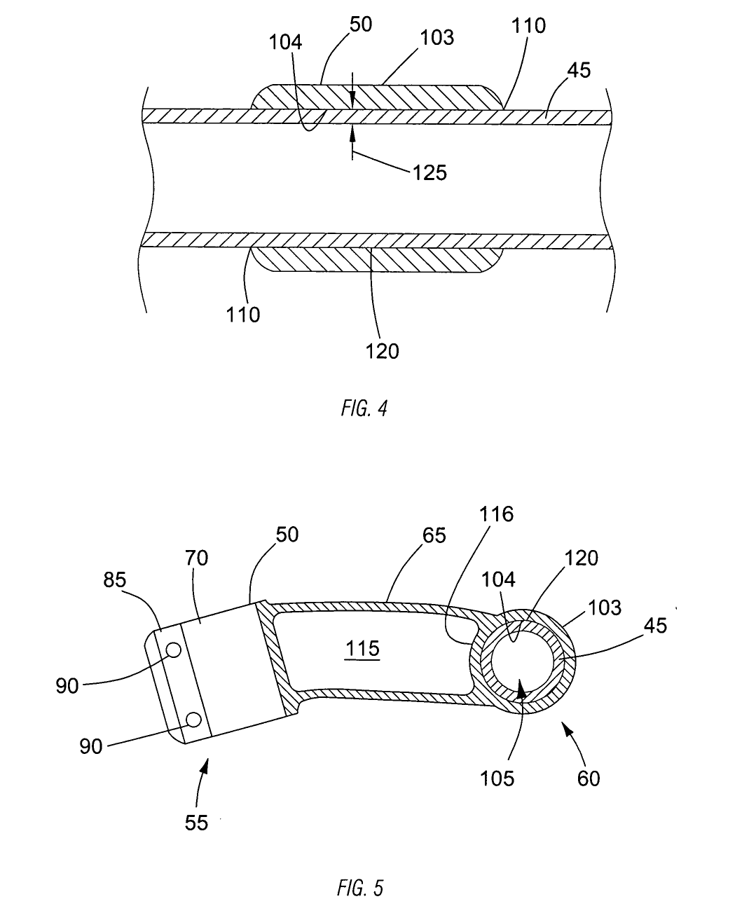

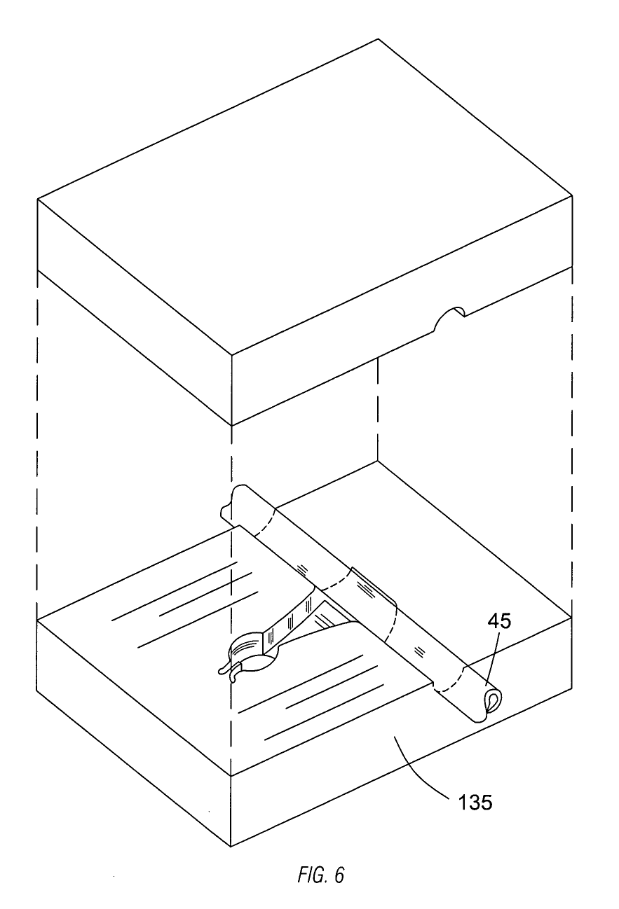

Turning to FIGS. 4 and 5, the handlebar-engaging end 60 includes an outer surface 103 and an inner cylindrical wall 104 that defines a handlebar aperture 105 (shown in FIG. 5) through which the handlebar 45 extends. The outer surface 103 is larger than the handlebar 45 and defines steps 110 (shown in FIG. 4) between the stem 50 and the handlebar 45. It should be noted that FIGS. 4 and 5 illustrate the handlebar 45 as being a separate component from the stem 50. While this is true during the manufacturing process, after manufacturing is complete, there is no separation between the two parts as they are integrated into a single steering interface 30.

As illustrated in FIG. 5, the wall portion 65 interconnects the steerer clamp end 55 and the handlebar-engaging end 60 to complete the stem 50. The wall portion 65 is substantially hollow and defines an interior space 115. The use of a hollow wall portion 65 reduces the weight of the steering interface 30, which in turn reduces the weight of the bicycle 10. The hollow wall portion 65 is optimal for composite lay-up, design, and manufacture as it requires less material to manufacture than would a solid stem 50. In some constructions, the interior space 115 is filled with a filler material. For example, plastic or foam can be injected into the space 115 to change some of the mechanical properties of the stem 50 without significantly increasing the weight of the stem 50. In still other constructions, a core, such as a honeycomb core is positioned within the interior space 115 as the stem 50 is formed.

The interface of the wall portion 65 and the handlebar-engaging end 60 defines a bonding web 116. The bonding web 116, shown in FIG. 5, is an arcuate portion that is curved to closely match the handlebar 45. In addition, the bonding web 116 assures that the handlebar 45 is completely surrounded by the stem 55 when the steering assembly is complete. Completely surrounding the handlebar 45 increases the surface area of the molded joint, thus providing a stronger steering interface 30.

The handlebar 45 is also preferably formed from a composite material, such as a carbon/epoxy composite, with other materials also being suitable for use (e.g., plastics, metals, other composites, and the like). The handlebar 45 generally includes an attachment portion 120 (shown in FIG. 4) that facilitates the attachment of the handlebar 45 to the stem 50. As shown in FIG. 4, the attachment portion 120 has the same wall thickness 125 and the same outside diameter as the rest of the handlebar 45. The wall thickness 125 is less than what was required in prior handlebars because the clamping forces have been eliminated. In addition, the wall thickness 125 can be smaller than prior handlebar wall thicknesses as the portion of the stem 50 that extends around the handlebar attachment portion 120 provides additional strength and reinforcement. In some constructions, the wall thickness in the attachment portion 120 remains substantially the same as the wall thickness adjacent the attachment portion 120, but the outside diameter of the attachment portion 120 is reduced (as is the inside diameter) as compared to the adjacent portions of the handlebar 45. This construction provides a space to receive material that forms the stem 50. In still another construction, the attachment portion defines a first wall thickness, while the portion of the handlebar adjacent the attachment portion defines a second wall thickness that is greater than the first wall thickness. Again, this construction provides a space to receive material that forms the stem 50. As one of ordinary skill in the art will realize, the handlebar 45 may include many different wall thicknesses in several different areas depending on expected loading conditions and other design considerations.

While there are many different procedures available to manufacture the steering assembly 30, one procedure begins by manufacturing the handlebar 45. Prepreg lay-up material is cut and layered onto a pattern or in a mold to define the handlebar 45. Generally, the prepreg material is made of woven or unidirectional carbon fibers that are impregnated with an adhesive such as epoxy. The attachment portion 120 can include less prepreg material than prior handlebars since there are not any compressive stem clamp crush forces. Once the composite lay-up is positioned as desired, the handlebar 45 is heated under pressure to cure the adhesive. The handlebar 45 may be ground, sanded, or machined to complete the manufacture of the handlebar 45. Of course, one of ordinary skill in the art will realize there are many ways of manufacturing a composite handlebar. As such, the invention should not be limited to the method described.

A stem mold 135, shown in FIG. 6, is provided to accommodate the lay-up of the stem 50. The composite lay-up required to define the lower portion of the stem 50 is positioned and oriented as desired within the mold 135. Again, prepreg material (i.e., material impregnated with an adhesive such as epoxy) is preferred. Next, the completed handlebar 45 is positioned within the mold 135 such that the attachment portion 120 of the handlebar 45 rests on top of some of the prepreg material positioned to define the bottom of the stem 50. By positioning the material needed for the lower portion of the stem 50 before positioning the handlebar 45, it is possible to wrap the material around the attachment portion 120 of the handlebar 45 to better integrate the two components 45, 50. In most constructions, an inflatable air bladder (not shown) is also positioned within the interior space 115 of the stem 50.

Additional material, if needed, is positioned within the mold 135 and integrated with the lower portion material that is wrapped around the handlebar 45. Once all the materials are positioned as desired, the stem mold 135 is closed, the mold is heated, and the bladder is expanded to pressurize the prepreg material. The bladder pushes the materials against the inside of the mold 135 to achieve the desired shape of the stem 50. The assembly is then cured to form a single integrated part that includes both the stem 50 and the handlebar 45. Once cured, the handlebar 45 and the stem 50 cannot be separated from one another without destroying or damaging the handlebar 45 and/or the stem 50. The formed steering assembly 30 is then machined, sanded, or ground to form the apertures 90, the split 80, and any other features that need additional accuracy or smoothing.

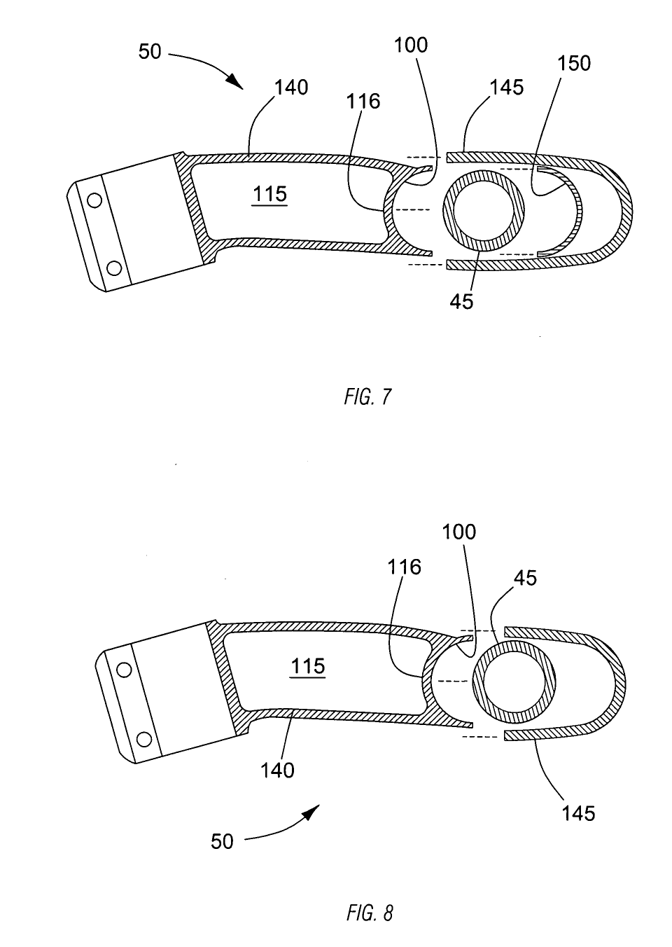

In another construction, illustrated in FIG. 7, the handlebar 45 is completely formed as it was in the previous example. The stem 50 is partially formed and cured such that it includes a complete inner cylindrical wall 100. The inner cylindrical wall 100 is then split along its largest diameter to separate the stem 50 into a stem portion 140 and a handlebar cover 150. The handlebar 45, the partial stem 140, and the handlebar cover 150 are then positioned adjacent one another and, in some constructions, bonded to one another using an adhesive such as epoxy. Additional prepreg material 145 is positioned to define a portion of the completed stem 50 and extend around the attachment portion 120 of the handlebar 45. The assembly is cured to complete the attachment of the handlebar 45 and the stem 50. The formed steering assembly 30 is then machined, sanded, or ground to form the apertures 90, the split 80, and any other features that need additional accuracy or smoothing.

In yet another construction illustrated in FIG. 8, the handlebar 45 is completely formed and cured, and the stem 50 is partially formed and cured as was described with regard to FIG. 7. The cylindrical wall 100 is again split along its diameter to define the stem portion 140 and a small portion equivalent to the handlebar cover 150, which is discarded. The handlebar 45 is positioned adjacent the stem portion 140 and bonded to the stem portion 140. Additional prepreg material 145 wraps around the handlebar 45 and forms part of the completed stem 50. The entire assembly is then cured to complete the attachment of the handlebar 45 to the stem 50. The formed steering assembly 30 is then machined, sanded, or ground to form the apertures 90, the split 80, and any other features that need additional accuracy or smoothing.

The methods just described allow for the manufacture of a steering assembly 30 that includes a visible step 110 on either side of the stem 50 between the stem 50 and the handlebar 45. The steps 110 give the appearance that the handlebar 45 is a separate component, when in reality the two parts 45, 50 are actually integrally-formed into a single steering interface 30. The shape of the steps 110 can be tailored or changed to achieve many different aesthetic appearances or can be eliminated if desired.

The invention described herein is well suited to clamping a composite part to another component. Other constructions may co-mold metallic hardware inside the apertures 90 of the composite stem 50. However, this arrangement is susceptible to debonding or delaminating at high clamp torques. In constructions in which a carbon/epoxy or other composite steerer tube 40 is employed, high clamp torques are generally required. The high clamp torque is needed due to the relatively low friction between carbon/epoxy-carbon/epoxy joints. In addition, the metallic hardware can strip as the high torque is applied. If the metallic hardware is stripped, the stem must be replaced as the co-molded hardware cannot be replaced. The clamp hardware members 91a, 91b of the present invention can be easily replaced without having to replace the stem 50.

In addition, the arrangement of the clamp portion 55 of the stem 50 allows for an improved composite lay-up. As illustrated in FIG. 11, composite fibers 230 can be arranged as desired. The extension of the flanges 85 away from the split 80 allows for improved fiber straightness as the cross section all around the cylindrical wall 70 is substantially constant. In addition, the arrangement of the clamp end 55 assures that as the clamp is tightened, the carbon/epoxy composite is placed in tension as is optimal for a carbon composite.

While the invention has been described as being applied to a clamp for attaching a stem 50 to a fork or steerer tube 40, one of ordinary skill in the art will realize that the invention could be used in other applications as well. For example, the invention is well suited for use to attach a handlebar to a stem or for use at the top of a seat tube to clamp the seat post to the seat tube. It should be recognized that in the case of clamping a tube to a tube (i.e., a seat post to a seat tube), the flanges can be molded in one part with the seat tube or used as a separate clamp over the seat tube. As such, the application of the invention should not be limited to clamp the end of a stem 50.

Thus, the invention provides, among other things, a new and useful steering interface 30 for a bicycle 10. More particularly, the invention provides a new and useful composite steering interface 30 that includes a clamp portion 55 formed as part of the steering interface 30 and adapted to fixedly attach the steering assembly 30 to a tube of a bicycle 10. Various features and advantages of the invention are set forth in the following claims.

What is claimed is:

1. A stem for a bicycle, the stem comprising:
a clamp portion defining a fork-receiving aperture having a size;
a first flange integrally-formed as part of the clamp portion and extending from the clamp portion;
a second flange integrally-formed as part of the clamp portion and extending from the clamp portion, the second flange spaced apart from the first flange;
a first clamp interface member in contact with the first flange; and
a second clamp interface member in contact with the second flange such that movement of one of the first clamp interface member and the second clamp interface member toward the other of the first clamp interface member and the second clamp interface member reduces the size of the fork-receiving aperture.

2. The stem of claim 1, wherein the clamp portion is formed from a composite material.

3. The stem of claim 1, wherein the fork-receiving aperture is substantially cylindrical and extends along an axis, and wherein the aperture includes a split that is substantially parallel to the axis.

4. The stem of claim 3, wherein the first flange is substantially parallel to the axis and is disposed on a first side of the split and the second flange is substantially parallel to the first flange and is disposed on a second side of the split opposite the first side.

5. The stem of claim 1, wherein the first clamp interface member includes a first aperture and a second aperture, and wherein only one of the first aperture and the second aperture includes threads.

6. The stem of claim 1, wherein the second clamp interface member is substantially the same as the first clamp interface member.

7. The stem of claim 1, wherein the first flange and the second flange each include two apertures and the first clamp interface member and the second clamp interface member each include one through bore and one threaded bore.

8. The stem of claim 7, further comprising a first fastener and a second fastener, the first fastener passing through the through bore of the first clamp interface member, one of the apertures of the first flange, one of the apertures of the second flange, and threadably engaging the threaded aperture of the second clamp interface member, the second fastener passing through the through bore of the second clamp interface member, one of the apertures of the first flange, one of the apertures of the second flange, and threadably engaging the threaded aperture of the first clamp interface member.

9. The stem of claim 1, wherein the first flange includes an exposed surface and the first clamp interface member includes a mating surface, the exposed surface and the mating surface having similar contours such that they maintain close contact with one another.

10. The stem of claim 9, wherein the exposed surface includes a first curved portion and the mating surface includes a second curved portion, the first curved portion being substantially the same as the second curved portion.

11. The stem of claim 1, wherein the first clamp interface member and the second interface member each have a length that is substantially equal to a length of the first flange.

12. A stem for a bicycle, the stem comprising:
a composite clamp portion defining a fork-receiving aperture having a split and an area;
a first clamp interface member in contact with the clamp portion and disposed on a first side of the split; and
a second clamp interface member in contact with the clamp portion and disposed on a second side of the split opposite the first side such that movement of one of the first clamp interface member and the second clamp interface member toward the other of the first clamp interface member and the second clamp interface member reduces the area of the fork-receiving aperture.

13. The stem of claim 12, wherein the fork-receiving aperture is substantially cylindrical and extends along an axis, and wherein the split is substantially parallel to the axis.

14. The stem of claim 12, further comprising a first flange integrally-formed as part of the clamp portion and being substantially parallel to the split and a second flange integrally-formed as part of the clamp portion and being substantially parallel to the split.

15. The stem of claim 14, wherein the first flange is disposed on a first side of the split and the second flange is disposed on a second side of the split, the second side opposite the first side.

16. The stem of claim 14, wherein the first flange and the second flange each include two apertures and the first clamp interface member and the second clamp interface member each include one through bore and one threaded bore.

17. The stem of claim 16, further comprising a first fastener and a second fastener, the first fastener passing through the through bore of the first clamp interface member, one of the apertures of the first flange, one of the apertures of the second flange, and threadably engaging the threaded aperture of the second clamp interface member, the second fastener passing through the through bore of the second clamp interface member, one of the apertures of the first flange, one of the apertures of the second flange, and threadably engaging the threaded aperture of the first clamp interface member.

18. The stem of claim 14, wherein the first flange includes an exposed surface and the first clamp interface member includes a mating surface, the exposed surface and the mating surface having similar contours such that they maintain close contact with one another.

19. The stem of claim 18, wherein the exposed surface includes a first curved portion and the mating surface includes a second curved portion, the first curved portion being substantially the same as the second curved portion.

20. The stem of claim 12, wherein the first clamp interface member includes a first aperture and a second aperture, and wherein only one of the first aperture and the second aperture includes threads.

21. The stem of claim 12, wherein the second clamp interface member is substantially the same as the first clamp interface member.

22. The stem of claim 12, wherein the first clamp interface member and the second interface member each have a length that is substantially equal to a length defined by the split.

23. A bicycle comprising:
a front wheel;
a front fork coupled to the front wheel and rotatable about a fork axis to turn the front wheel;
a stem including a clamp portion, the clamp portion movable between a first position and a second position in which the stem is fixedly coupled to the fork;
a first clamp interface member coupled to the clamp portion;
a second clamp interface member substantially the same as the first clamp interface member and coupled to the clamp portion;
a fastener coupled to the first clamp interface member and the second clamp interface member and operable to move the clamp portion between the first position and the second position; and
a handlebar coupled to the stem.

24. The bicycle of claim 23, wherein the stem is formed from a composite material.

25. The bicycle of claim 23, wherein the stem and the handlebar are integrally-formed as a single component from a composite material.

26. The bicycle of claim 23, further comprising a first flange integrally formed as part of the clamp portion and a second flange integrally formed as part of the clamp portion.

27. The bicycle of claim 26, wherein the first flange and the second flange each include two apertures and the first clamp interface member and the second clamp interface member each include one through bore and one threaded bore.

28. The bicycle of claim 27, further comprising a second fastener, the fastener passing through the through bore of the first clamp interface member, one of the apertures of the first flange, one of the apertures of the second flange, and threadably engaging the threaded aperture of the second clamp interface member, the second fastener passing through the through bore of the second clamp interface member, one of the apertures of the first flange, one of the apertures of the second flange, and threadably engaging the threaded aperture of the first clamp interface member.

29. The bicycle of claim 26, wherein the first flange includes an exposed surface and the first clamp interface member includes a mating surface, the exposed surface and the mating surface having similar contours such that they maintain close contact with one another.

30. The stem of claim 29, wherein the exposed surface includes a first curved portion and the mating surface includes a second curved portion, the first curved portion being substantially the same as the second curved portion.

31. The bicycle of claim 23, wherein the first clamp interface member includes a first aperture and a second aperture, and wherein only one of the first aperture and the second aperture includes threads.

32. The stem of claim 23, wherein the first clamp interface member and the second interface member each have a length that is substantially equal to a length defined by the clamp portion.
